(19) United States
(12) Patent Application Publication
(10) Pub. No.: US 2026/0281292 A1
(43) Pub. Date: Sep. 17, 2026

(54) HEAD-MOUNTED DISPLAY AND IMAGE DISPLAY METHOD

(71) Applicant: Sony Interactive Entertainment Inc., Tokyo (JP)

(72) Inventors: Mitsuru Nishibe, Chiba (JP); Haruka Iwaki, Kanagawa (JP); Kuniaki Oe, Tokyo (JP); Takanori Minamino, Kanagawa (JP)

(73) Assignee: Sony Interactive Entertainment Inc., Tokyo (JP)

(21) Appl. No.: 19/157,657

(22) PCT Filed: Feb. 14, 2024
(86) PCT No.: PCT/JP2024/005095

§ 371 Date: Aug. 18, 2025

(30) Foreign Application Priority Data
Mar. 6, 2023 (JP) 2023-033694

(51) Int. Cl. H04N 13/117; G02B 27/01; G06T 19/00; H04N 13/239; H04N 13/279; H04N 13/332; H04N 13/373; H04N 13/376; H04N 13/378; H04N 13/38

(52) U.S. Cl. CPC H04N 13/117; G02B 27/0172; G06T 19/006; H04N 13/239; H04N 13/279; H04N 13/332; H04N 13/373; H04N 13/376; H04N 13/378; H04N 13/38; G02B 2027/0138; G02B 2027/014; G02B 2027/0187

(57) ABSTRACT

An image processing section of a head-mounted display sets a control plane 350 corresponding to distribution of distances from a user 280 to real objects 354a and 354b in a virtual three-dimensional space. The control plane 350 is updated according to movement of the user 280. The image processing section decides a virtual distance ds of a superimposed image in the virtual three-dimensional space on the basis of a distance dc from the user 280 to a control plane in a line-of-sight direction, places the superimposed image in the virtual three-dimensional space, and then renders a view as seen from a virtual camera on a see-through image.

### TECHNICAL FIELD

The present invention relates to a head-mounted display that displays a superimposed image in a visual field, and an image display method.

### BACKGROUND ART

Image display systems that make it possible to view a target space from free viewpoints have been used more widely. For example, there is a developed system that causes a panoramic video to be displayed on a head-mounted display, and causes an image according to the line-of-sight direction of a user wearing the head-mounted display to be displayed. By using a head-mounted display, it is possible to enhance the sense of immersion into a video, enhance the operability of an application such as a game, and so on.

In addition, a technology to realize augmented reality (AR) or mixed reality (MR) by providing a video camera that captures images of a real space to a head-mounted display and synthesizing computer graphics with the captured images has also been put into practical use. Alternatively, by displaying the captured images promptly, a user can easily check the view around her/him even if the head-mounted display is a shielded head-mounted display. Furthermore, it is made possible also to check information while the user is viewing the real world using a light-transmissive wearable display.

### Technical Problems

In technologies like the ones described above, it is desired to superimpose and display various types of information such as dialog boxes, help screens, control panels, or indicators while a main real space or a virtual space is being viewed stereoscopically, in some cases. Such superimposed images are typically caused to appear on the front plane as window-like images with simple two-dimensional structures due to the nature of the display content, independently of other displayed elements. However, in a situation where the main image is being viewed stereoscopically, such superimposed images can look unnatural, or it can be difficult to adjust the focus. There is also a possibility that users experience physical discomfort such as visually induced motion sickness in some cases.

The present invention has been made in view of such problems, and an object thereof is to provide a technology that enables easy and natural visual perception of superimposed images in a display that realizes stereoscopic view such as a head-mounted display.

### Solution to Problems

In order to solve the problems described above, an aspect of the present invention relates to a head-mounted display. The head-mounted display is a head-mounted display that realizes stereoscopic view, and includes a control plane generating section that sets a control plane corresponding to distribution of distances between a user and real objects in a display-target virtual three-dimensional space, a superimposed image control section that decides a virtual distance of a superimposed image that should be displayed, according to a distance to the control plane in a line-of-sight direction, a display image generating section that generates data of a display image including the superimposed image in a state where the superimposed image is placed at the virtual distance in the three-dimensional space, and an output control section that outputs the data of the display image to a display panel.

Another aspect of the present invention relates to an image display method. The image display method is performed by a head-mounted display that realizes stereoscopic view, and includes a step of setting a control plane corresponding to distribution of distances between a user and real objects in a display-target virtual three-dimensional space, a step of deciding a virtual distance of a superimposed image that should be displayed, according to a distance to the control plane in a line-of-sight direction, a step of generating data of a display image including the superimposed image in a state where the superimposed image is placed at the virtual distance in the three-dimensional space, and a step of outputting the data of the display image to a display panel.

Note that any combination of constituent elements above, and ones that are obtained by conversion of expressions of the present invention between a method, an apparatus, a system, a computer program, a data structure, a recording medium, and the like are also effective as aspects of the present invention.

### Advantageous Effect of Invention

The present invention enables easy and natural visual perception of superimposed images in a display that realizes stereoscopic view such as a head-mounted display.

### BRIEF DESCRIPTION OF DRAWINGS

FIG. 1 is a drawing depicting an appearance example of a head-mounted display of the present embodiment.

FIG. 2 is a drawing depicting a configuration example of an image display system of the present embodiment.

FIG. 3 is a drawing schematically depicting data paths in the image display system of the present embodiment.

FIG. 4 is a drawing schematically depicting a see-through-mode image displayed by the head-mounted display in the present embodiment and an image synthesized with a superimposed image.

FIG. 5 is a drawing depicting a position of a superimposed image and examples of left eye and right eye images when taking into consideration the depth axis of a three-dimensional space in the present embodiment.

FIG. 6 is a drawing for explaining a principle for deciding a virtual distance of a superimposed image in the present embodiment.

FIG. 7 is a drawing for explaining a specific technique to decide a virtual distance of a superimposed image in the present embodiment.

FIG. 8 is a drawing for outlining a principle of visual simultaneous localization and mapping (SLAM) that can be used for the present embodiment.

FIG. 9 is a diagram depicting an internal circuit configuration of the head-mounted display in the present embodiment.

FIG. 10 is a diagram depicting a configuration of functional blocks of an image processing section included in the head-mounted display of the present embodiment.

FIG. 11 is a flowchart depicting a processing procedure by which the image processing section of the head-mounted display causes a superimposed image to be displayed in a see-through mode in the present embodiment.

FIG. 12 is a drawing for explaining an example in which a cube map is used as a data format of a control plane map in the present embodiment.

FIG. 13 is a drawing for explaining an example of a filtering process that a control plane generating section implements on the control plane map in the present embodiment.

FIG. 14 is a drawing depicting an example of changes in a diagonal element Dᵢ corresponding to changes in a Laplacian Δpᵢ of i-th piece of positional information pᵢ in the present embodiment.

FIG. 15 is a drawing for explaining a principle for deciding virtual distances when a plurality of superimposed images are displayed at different distances in the present embodiment.

### DESCRIPTION OF EMBODIMENT

The present embodiment relates to an apparatus that causes an image prepared separately from an image in a three-dimensional space to be superimposed and displayed in a state where the image in the three-dimensional space is being viewed stereoscopically. The three-dimensional space may be a real space or may be a virtual space. An image representing a real space may be an image captured with a camera or may be an image transmitted through an optical system. That is, the apparatus of the present embodiment may display only a superimposed image or may synthesize a superimposed image while an image in a three-dimensional space is being displayed. In an aspect to be explained hereinafter, mainly, a superimposed image is synthesized while an image including a captured image is being displayed on a head-mounted display.

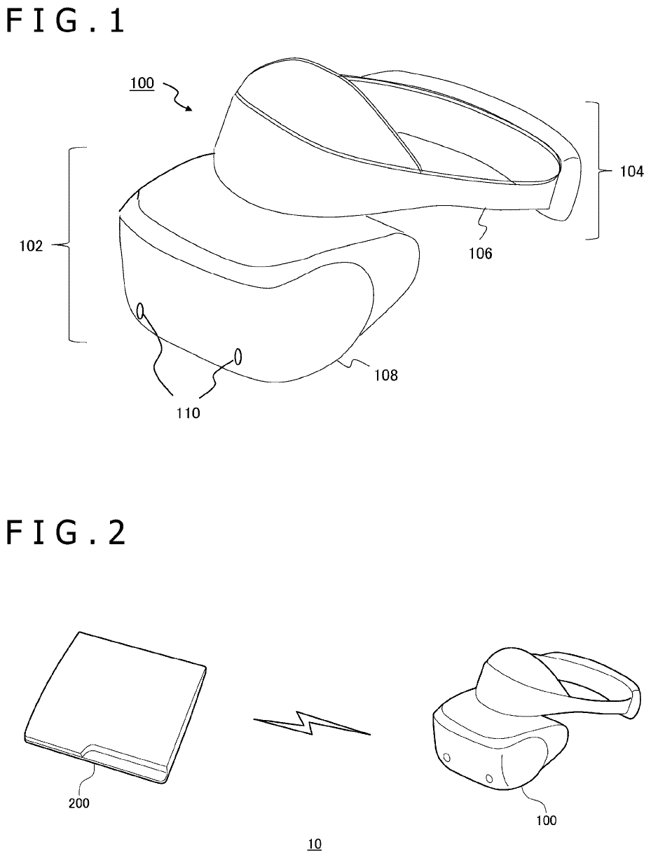

FIG. 1 depicts an appearance example of a head-mounted display 100. In this example, the head-mounted display 100 includes an output mechanism section 102 and an attachment mechanism section 104. The attachment mechanism section 104 includes an attachment band 106 that realizes the fixing of the apparatus by encircling a user's head when the user wears it. The output mechanism section 102 includes a housing 108 in such a shape that covers the left and right eyes of the user in a state where the user is wearing the head-mounted display 100, and internally includes a display panel such that it directly faces the eyes when the user is wearing the head-mounted display 100.

Eye pieces that are positioned between the display panel and the eyes of the user when the user is wearing the head-mounted display 100 and that present enlarged images are further included inside the housing 108. The head-mounted display 100 may further include speakers or earphones at positions corresponding to the ears of the user when the user is wearing the head-mounted display 100. In addition, the head-mounted display 100 has a built-in motion sensor, senses translational movement or rotary movement of the head of the user who is wearing the head-mounted display 100, and consequently senses the position and posture of the head at each time.

The head-mounted display 100 further includes a stereo camera 110 on the front surface of the housing 108. The present embodiment provides a mode in which a real-space view in a direction in which the user is facing is presented as is by displaying, with low latency, a moving image captured with the stereo camera 110. Hereinafter, such a mode is called a “see-through mode.” For example, the head-mounted display 100 automatically switches to the see-through mode during a period in which images of content are not being displayed.

Hence, the user can check her/his surroundings without removing the head-mounted display 100 before the start of content, after the end of content, or during interruptions of content. In addition, the see-through mode may be started or ended in response to an operation explicitly performed by the user, as a trigger. Hence, even during content viewing, the user can temporarily switch the display to real-space images at any timing, and can perform necessary tasks such as handling unexpected events in the real world. Note that, whereas the stereo camera 110 is provided at the lower portion of the front surface of the housing 108 in the example illustrated in the drawing, its placement is not limited particularly. In addition, cameras other than the stereo camera 110 may be provided.

Images captured with the stereo camera 110 can be used also as images of content. For example, by synthesizing a virtual object with a captured image, with a position, posture, and movement aligned with real objects in the visual field of the camera, and displaying the synthesized image, AR and MR can be realized. In addition, independently of whether or not captured images are included in the display, it is also possible to analyze the captured images and use the results to decide the position, posture, and movement of objects to be rendered.

For example, by implementing stereo matching on captured images, corresponding points of images of a subject may be extracted, and the distance to the subject may be acquired using the principle of triangulation. Alternatively, by a well-known technology such as Visual SLAM, the position and posture of the head-mounted display 100 and the position and posture of the user's head relative to the surrounding space may be acquired, consequently. Visual SLAM is a technology to simultaneously perform self-position estimation of a mobile body on which a camera is mounted and creation of an environmental map using captured images. By these processes, it is possible to render and display a virtual world in a visual field corresponding to the viewpoint position and line-of-sight direction of the user.

FIG. 2 depicts a configuration example of an image display system in the present embodiment. In an image display system 10, the head-mounted display 100 is connected to a content processing apparatus 200 by wireless communication or an interface that connects peripheral equipment such as universal serial bus (USB) Type-C. The content processing apparatus 200 may further be connected to a server via a network. In that case, the server may provide, to the content processing apparatus 200, an online application such as a game that a plurality of users can participate in, via the network.

The content processing apparatus 200 is basically an information processing apparatus that processes content to generate a display image and transmits the display image to the head-mounted display 100 to cause the display image to be displayed. Typically, the content processing apparatus 200 identifies the viewpoint position and line-of-sight direction of the user who is wearing the head-mounted display 100 on the basis of the position and posture of the head of the user, and generates a display image in a visual field corresponding to the viewpoint position and the line-of-sight direction. For example, the content processing apparatus 200 may generate images representing a virtual world which is a game stage, while a storyline of the electronic game progresses, and may realize virtual reality (VR).

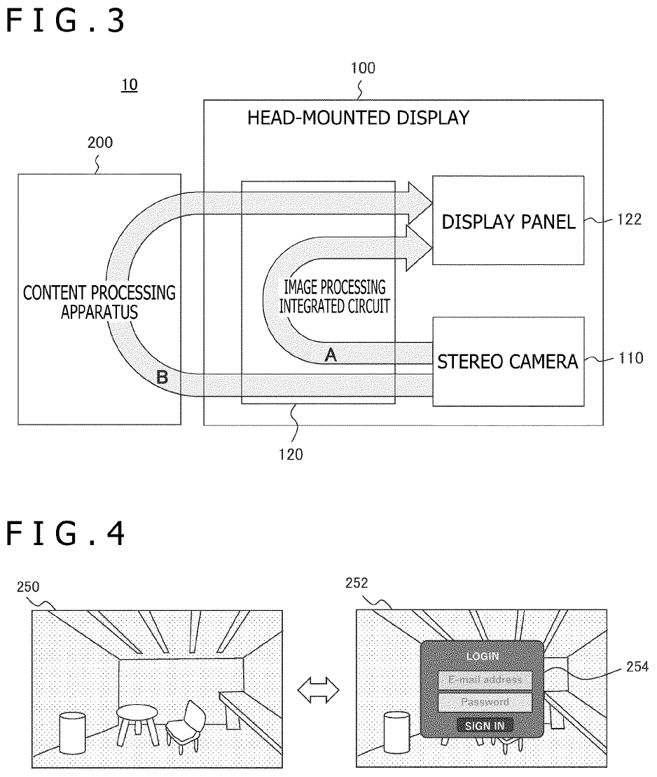

FIG. 3 schematically depicts data paths in the image display system 10 of the present embodiment. As mentioned above, the head-mounted display 100 includes the stereo camera 110 and a display panel 122. The display panel 122 is a panel having a typical display mechanism such as a liquid crystal display or an organic electroluminescent (EL) display. In the present embodiment, the display panel 122 displays left eye and right eye images included in a frame of a moving image in left and right areas that directly face the left eye and right eye of the user, respectively.

By using the left eye image and the right eye image as a stereoscopic image having parallax corresponding to the interval between the eyes, it is possible to present a display target stereoscopically. The display panel 122 may include two panels which are a left eye panel and a right eye panel that are placed next to each other side by side or may be one panel that displays an image formed by connecting a left eye image and a right eye image side by side.

The head-mounted display 100 further includes an image processing integrated circuit 120. For example, the image processing integrated circuit 120 is a system-on-chip on which various functional modules including a central processing unit (CPU) are mounted. Note that, in addition, as mentioned above, the head-mounted display 100 may include motion sensors such as a gyro sensor, an acceleration sensor, and an angular acceleration sensor, a main memory such as a dynamic random access memory (DRAM), an audio circuit that allows the user to hear sounds, a peripheral equipment interface circuit for connecting peripheral equipment, and the like, but these illustrations are omitted here.

The drawing depicts, with arrows, two data paths for cases where images captured with the stereo camera 110 are included in the display. In a case where AR or MR is realized, typically, images captured with the stereo camera 110 are taken into a content processing section, and the images are synthesized with virtual objects there to generate a display image. In the illustrated image display system 10, the content processing section is the content processing apparatus 200, and accordingly, as represented by an arrow B, images captured with the stereo camera 110 are transmitted to the content processing apparatus 200 tentatively through the image processing integrated circuit 120.

Then, the images are synthesized with virtual objects, and so on, are returned to the head-mounted display 100, and are displayed on the display panel 122. In contrast, in a case of the see-through mode, as represented by an arrow A, images captured with the stereo camera 110 can be corrected such that the images become suited for the display by the image processing integrated circuit 120, and displayed on the display panel 122. According to the path of the arrow A, the data transfer path becomes short significantly as compared with the path of the arrow B. Accordingly, the time from image capturing to display can be shortened, and the power consumption required for transfer can be reduced.

Note that this does not intend to limit the data path of the see-through mode in the present embodiment to the data path of the arrow A. That is, the path of the arrow B may be adopted, and images captured with the stereo camera 110 may be transmitted tentatively to the content processing apparatus 200. Then, the images may be corrected as display images on the side of the content processing apparatus 200, and then may be returned to the head-mounted display 100 for display, in another possible configuration.

In any case, in the present embodiment, favorably, images captured with the stereo camera 110 are sequentially pipeline-processed in units smaller than one frame such as in the unit of lines, thereby minimizing the time required to display the images. This lowers a possibility that a video is displayed with latency relative to head movement and the user experiences a sense of discomfort or visually induced motion sickness.

FIG. 4 schematically depicts a see-through-mode image displayed by the head-mounted display 100 and an image synthesized with a superimposed image. An image 250 is one frame of an image (hereinafter, called a see-through image) in the see-through mode, and corresponds to an image, which has been captured with the stereo camera 110, of the view of an indoor space in front of the head-mounted display 100. Actually, as mentioned above, a pair of left eye and right eye images of the same object that are horizontally offset by the amount of parallax is generated, and is displayed in the left and right areas of the display panel 122. In addition, it is assumed that, when display images are generated from captured images, the angle of view is corrected as appropriate.

Certainly, if the user changes a direction of her/his face, the visual field of a see-through image 250 also changes. In this state, the head-mounted display 100 displays an image 252 synthesized with a superimposed image 254 according to a request from the user, a system requirement, or the like. In the example in the drawing, a dialog box for the user to input an address and a password for login is displayed. After the user inputs necessary information to the dialog box, the head-mounted display 100 hides the superimposed image 254, and restores the display to the original see-through image 250.

In a case where the superimposed image 254 is displayed on part of the display image realizing stereoscopic view as illustrated in the drawing, it is necessary to configure settings taking into consideration a display-target three-dimensional space. Specifically, it is required to decide the position of the object of the superimposed image 254 including the position along the depth axis and generate a left and right image pair with parallax corresponding to the position. Note that a superimposed image object placed in a three-dimensional space is also expressed as a “superimposed image” in the following explanation in some cases.

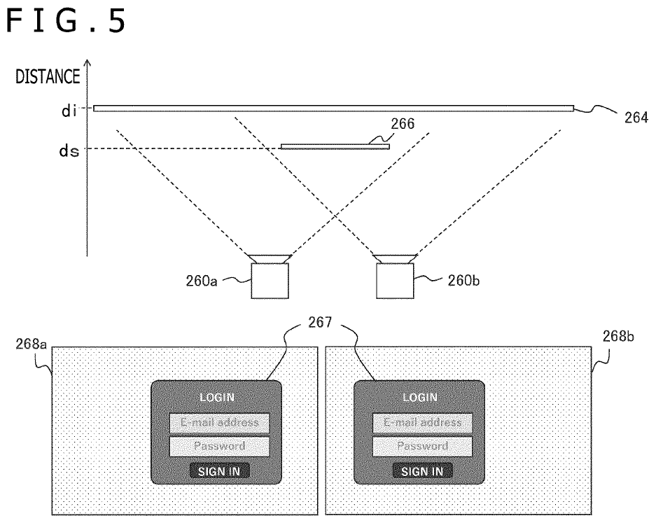

FIG. 5 depicts a position of a superimposed image and examples of left eye and right eye images taking into consideration the depth axis of a three-dimensional space. The top side of the drawing depicts a state as seen in a bird's-eye view of a virtual three-dimensional space configured at the time of display image generation. Virtual cameras 260a and 260b are virtual rendering cameras for generating a display image, and the upward direction in the drawing represents the depth direction (distances from the virtual cameras 260a and 260b). In a normal state where a superimposed image is not displayed, for example, the head-mounted display 100 places a see-through image 264 at a predetermined distance di in a virtual space.

Note that a stereoscopic image captured with the stereo camera 110 may be actually used to place the see-through image 264 in each of the left eye system and the right eye system. When it becomes necessary to display a superimposed image 267, for example, the head-mounted display 100 places a superimposed image 266 at a distance ds in the virtual space. In both cases where only the see-through image 264 is placed and where the superimposed image 266 is additionally placed, images as seen from the virtual cameras 260a and 264b are rendered, and hence left eye and right eye display images are generated.

The bottom side of the drawing schematically depicts a left eye display image 268a and a right eye display image 268b. Note that the see-through image is omitted in both of the display images, and only the superimposed image 267 is displayed. Since the virtual cameras 260a and 260b have parallax, the superimposed image 267 is displayed at horizontally offset positions on the planes of the left and right display images 268a and 268b. The offset amount changes depending on the distance ds of the superimposed image 266 in the three-dimensional space. Hence, the user perceives a sense of distance in the superimposed image 267.

Whereas the see-through image 264 is depicted as a single plane positioned at the same distance in the drawing, in a case where stereoscopic view is being realized, the images of real objects are displayed in left eye and right eye images with various offset amounts according to their actual positions. Hence, the positions of the images perceived by the user are distributed along the depth direction. The distribution can change significantly depending on the location where the user is or the direction in which the user is facing. For example, when the user who is looking at a distant wall where there are no objects placed shifts her/his line of sight to a nearby table, certainly, the distribution of image distances change significantly.

If the distance ds of the superimposed image 266 is fixed regardless of such irregular changes, there is a possibility that inconsistencies occur in expression of the three-dimensional space. For example, unnatural images are displayed where a real object partially overlapping the superimposed image 266 is hidden by the superimposed image 266 despite the fact that the real object is positioned in front of the superimposed image 266 according to a sense of distance. Such images can be a cause of difficulties for the eyes to focus or visually induced motion sickness.

To prevent the occurrence of spatial inconsistencies, one possible solution is to constantly place the superimposed image 266 at a very close distance to the virtual cameras 260a and 260b. However, in this case, if a visual field includes only distant real objects, the distance in the depth direction from the superimposed image 266 becomes too long. As expected, it becomes difficult to focus, and this can cause visual discomfort and eye strain. Such issues can occur not only with the images of real objects in a see-through image, but similarly with the positional relation between a superimposed image and real objects, objects in a virtual world, and the like that are viewed on a light-transmissive wearable display.

In view of this, in the present embodiment, the virtual distance given to a superimposed image is decided according to the state of a three-dimensional space in a visual field. For example, the head-mounted display 100 acquires the distribution of the distances from a user to real objects, and decides a virtual distance of a superimposed image according to the distances to real objects in a visual field. Hence, it is possible to merge the main image world and the superimposed image without inconsistencies and to reduce visual discomfort also.

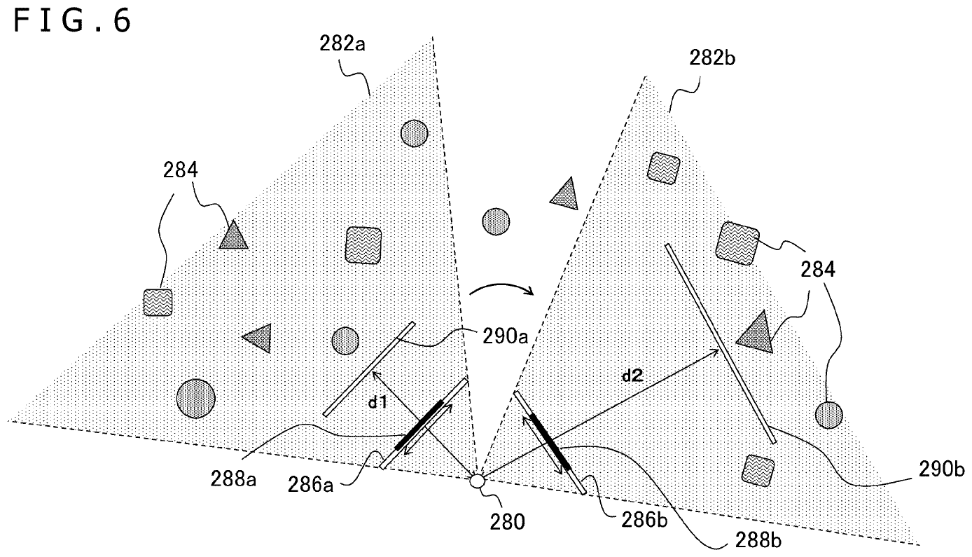

FIG. 6 is a drawing for explaining a principle for deciding a virtual distance of a superimposed image in the present embodiment. The drawing schematically depicts, as a bird's-eye view, the positional relation among see-through image visual fields 282a and 282b extending from a user 280 and surrounding real objects (e.g., real objects 284). When the see-through image visual field is at the visual field 282a, real objects in the visual field are distributed relatively close to the user 280. In the see-through mode, the images of the objects are projected onto and displayed on a view screen 286a.

In a case where a superimposed image 288a is displayed as depicted in black on the view screen 286a, the head-mounted display 100 decides a virtual distance d1 of a superimposed image object 290a in the three-dimensional space. At this time, the head-mounted display 100 decides the virtual distance d1 such that the superimposed image object 290a is positioned in front of the range where real objects are distributed.

Here, assume that the user 280 rotates her/his head to the right and the see-through image visual field changes to the visual field 282b. In the visual field 282b, real objects are distributed relatively farther from the user 280. In a case where a superimposed image 288b is displayed on a view screen 286b in this state, the head-mounted display 100 newly decides a virtual distance d2 of a superimposed image object 290b.

Compared with the visual field 282a, in the visual field 282b, objects are distributed farther in the angle of view corresponding to the display area of the superimposed image 288b. Accordingly, the appropriate virtual distance d2 is greater than the virtual distance d1. In response to such a change, the head-mounted display 100 enlarges the size of the superimposed image object 290b both vertically and horizontally at a rate which is the same as the rate of the change in virtual distance. Hence, the size of the superimposed image 288b on the view screen 286b is kept the same, and the ease of viewing of characters and the like is maintained independently of the virtual distance.

Whereas the visual field 282a and the visual field 282b are depicted representatively in the drawing, there is actually a transitional state during the change from the visual field 282a to the visual field 282b. If the virtual distance is switched discontinuously from D1 to D2 in a case where the user 280 rotates her/his head while the superimposed image is kept displayed, this results in sudden movement of the superimposed image that the user 280 has been viewing until then, causing visual discomfort or a sense of discomfort. In addition, there is also a fear that the superimposed image varies subtly due to measurement noise in the distances to real objects, and this appears to be a malfunction undesirably.

Furthermore, as a result of time that has been required from the acquisition of the distances to real objects to the derivation of a virtual distance, a superimposed image moves with latency relative to the rotation of a user's head. This can lead to a state where the superimposed image is moving despite the fact that a see-through image visual field has stopped already. In view of this, in the present embodiment, by estimating the distribution of the approximate distances to real objects continuously in advance as a continuous plane surrounding a user, the virtual distance of the superimposed image is changed continuously and immediately in response to changes in the line of sight following the rotation of the head of the user.

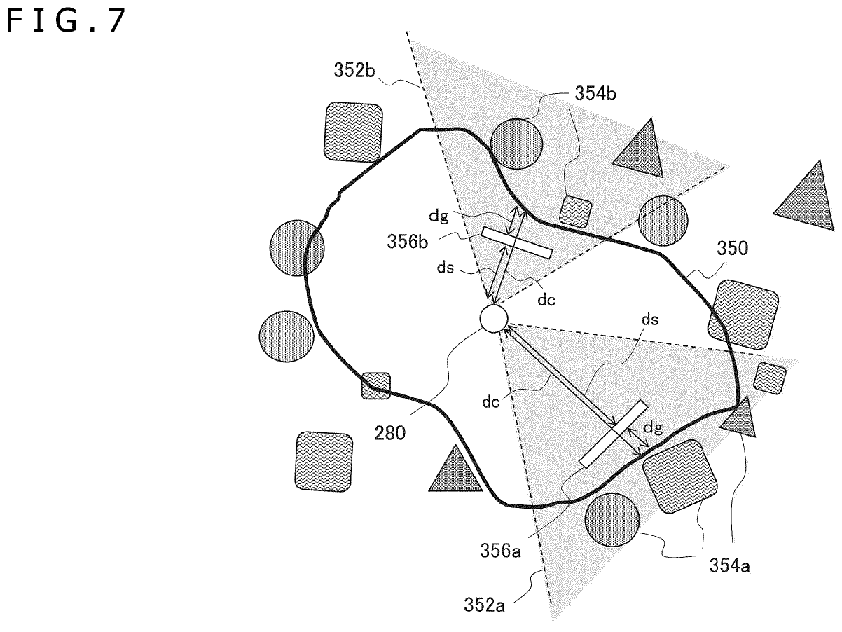

FIG. 7 is a drawing for explaining a specific technique to decide a virtual distance of a superimposed image in the present embodiment. The drawing schematically depicts the bird's-eye view of the user 280 and surrounding real objects (e.g., real objects 354a and 354b), similarly to FIG. 6. In the present embodiment, the distances from the user to the real objects are acquired as distribution relative to directions centered around the user 280, and a plane approximately corresponding to the distribution of distances is prepared as a control plane 350. The control plane 350 is a plane that represents the distribution of the actual distances to the real objects at a lower resolution, and represents more smoothed distribution. The control plane 350 provides a macroscopic indication of the boundary of an area where there are the real objects.

During a period in which a superimposed image is displayed, the head-mounted display 100 places superimposed image objects 356a and 356b on the basis of the control plane 350. For example, the head-mounted display 100 places the superimposed image objects 356a and 356b in front of the control plane 350 (on the side of the user 280) by a predetermined interval dg in the line-of-sight direction of the user 280. The interval dg may have a fixed value or may be a variable decided by a predetermined rule according to a distance dc to the control plane 350 in the line-of-sight direction of the user 280.

By deciding a virtual distance ds of the superimposed image objects 356a and 356b on the basis of the control plane 350 such that the virtual distance ds corresponds to the magnitude of the distance dc, for example, the superimposed image object 356a is also placed farther in a visual field 352a in which the real object 354a is farther, and the superimposed image object 356b is also placed closer in a visual field 352b in which a real object 354b is closer.

Since the control plane 350 is a continuous plane, superimposed image objects 306a and 306b can be moved continuously along with the control plane 350 even if the user 280 rotates her/his head while the superimposed image is kept displayed. Whereas the drawing depicts a horizontal cross-section of the control plane 350, the control plane 350 may be a plane surrounding all directions centered around the user 280. By preparing in advance the control plane 350 in a range wider than the visual field, favorably in all directions from the user 280, even if the visual field has changed rapidly due to a sudden turn of the user or the like, the superimposed image can be kept at a proper distance so as to follow the changes.

As a result, it is easier to avoid a situation where, when the user has stopped the rotation of her/his head, the adjustment of the virtual distance ds of the superimposed image has not been completed, and only the superimposed image is moving although the see-through image visual field is stationary. In many cases, the user gazes at a display image during a period when the user has stopped her/his head. Accordingly, the adjustment of the virtual distance ds of the superimposed image has approximately been completed during the rotation of the head, and this can prevent the user from being aware of the adjustment process and reduce the cognitive load of the user.

As mentioned above, the control plane 350 is a smoothed plane serving as a macroscopic indication of the distribution of the actual distances to real objects. Hence, when the user 280 rotates her/his head, the superimposed image no longer varies subtly or exhibits discontinuous movement. Because of this, it is not necessary to precisely determine the distances to the real objects, and the processing load required for the generation of the control plane 350 can be reduced. For example, in a case where Visual SLAM is used for the tracking of the head-mounted display 100, the results can be repurposed to further reduce the processing load.

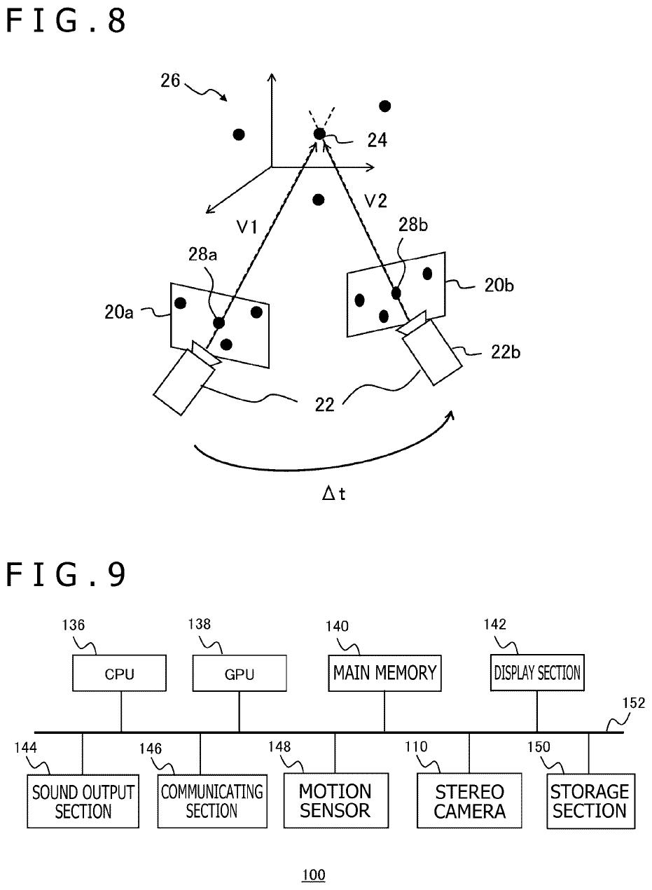

FIG. 8 is a drawing for outlining a principle of Visual SLAM. A camera 22 is provided to a mobile body, and is capturing a video of a real space 26 in its viewing range while changing its position and posture. It is assumed here that feature points 28a and 28b representing a point 24 on the same real object are extracted in a frame 20a captured at a particular time and a frame 20b captured after a time Δt. Note that feature points in a captured image can be sensed by a known technique such as a corner sensing method.

The offset between the positional coordinates of the corresponding feature points 28a and 28b in the respective frame planes depends on the change in the position and posture of the camera 22 during the time Δt. Specifically, assuming that R and T are matrices representing the amounts of changes caused by rotary movement and translational movement of the camera 22, respectively, and V1 and V2 are three-dimensional vectors from the camera 22 to the point 24 at the respective times, the following relational expression holds true.

$$V 1 = R \cdot V 2 + T$$

By using this relation to extract a plurality of corresponding feature points in the two temporally sequential frames and solving simultaneous equations, the change in the position and posture of the camera 22 during the time period can be identified. In addition, by a process of minimizing the error in the derived result by recursive computations, three-dimensional information regarding a real object surface in the real space 26 such as the point 24 can be generated as an environmental map. Note that, if it is assumed that the camera 22 is the stereo camera 110, the three-dimensional positional coordinates of the point 24 and the like can be determined independently for each time, and accordingly, arithmetic operations for the extraction of corresponding points and the like become easier.

In addition, there are a large number of algorithms of Visual SLAM proposed, and there are no problems even if any of them is adopted. In any case, according to the illustrated principle, the position and posture of the camera 22 can be derived at the same rate as the frame rate of a moving image, and the three-dimensional positional coordinates of real objects can be determined in the unit of sensed feature points. In the present embodiment, data serially generated by the Visual SLAM is used to acquire the distances to real objects at a predetermined rate and cause a control plane to reflect the distances.

FIG. 9 depicts the internal circuit configuration of the head-mounted display 100. The head-mounted display 100 includes a CPU 136, a graphics processing unit (GPU) 138, a main memory 140, and a display section 142. These respective sections are interconnected via a bus 152. The bus 152 is further connected with a sound output section 144, a communicating section 146, a motion sensor 148, the stereo camera 110, and a storage section 150. Note that the configuration of the bus 152 is not limited, and, for example, a plurality of buses may be connected by an interface.

The CPU 136 performs the overall control of the head-mounted display 100 by executing an operating system stored on the storage section 150. In addition, the CPU 136 executes various types of program retrieved from the storage section 150 and loaded onto the main memory 140 or downloaded via the communicating section 146. The GPU 138 performs image rendering or correction in accordance with a rendering command from the CPU 136. The main memory 140 includes a random access memory (RAM), and stores programs and data necessary for processes.

The display section 142 includes the display panel 122 depicted in FIG. 3, and displays images in front of the eyes of a user who is wearing the head-mounted display 100. The sound output section 144 includes speakers or earphones provided at positions corresponding to the ears of the user when the user is wearing the head-mounted display 100, and allows the user to hear sounds.

The communicating section 146 is an interface for the transmission and reception of data to and from the content processing apparatus 200, and realizes communication by a known wireless communication technology such as Bluetooth (registered trademark) or a wired communication technology. The motion sensor 148 includes a gyro sensor, an acceleration sensor, an angular acceleration sensor, and the like, and acquires the inclination, acceleration, angular velocity, and the like of the head-mounted display 100. As depicted in FIG. 1, the stereo camera 110 includes a pair of video cameras that capture images of a surrounding real space from left and right viewpoints. The storage section 150 includes a storage such as a read only memory (ROM).

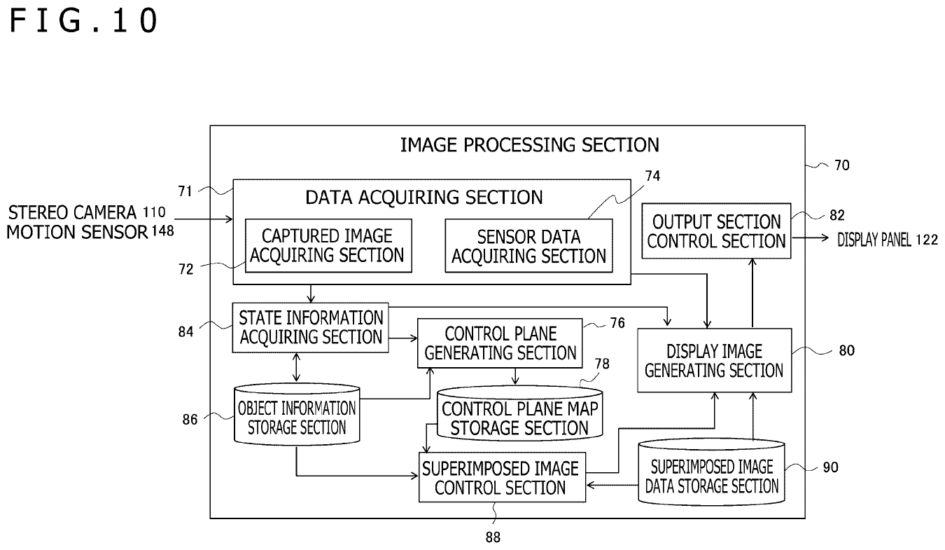

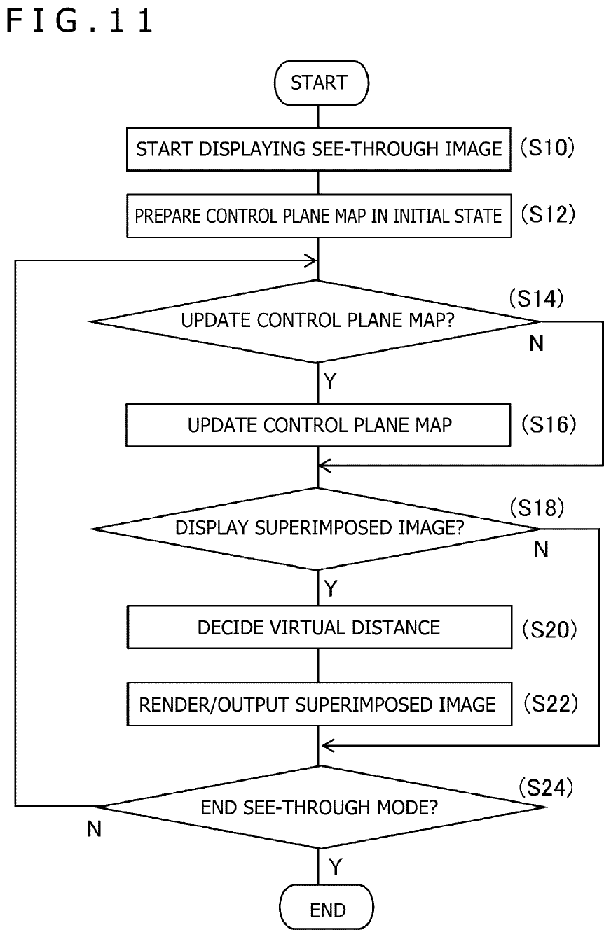

FIG. 10 depicts a configuration of functional blocks of an image processing section included in the head-mounted display 100 of the present embodiment. The illustrated functional blocks can be realized hardware-wise by the circuit configuration depicted in FIG. 9, and are realized software-wise by a program that is loaded from the storage section 150 onto the main memory 140 and exhibits functions such as a data input function, a data retaining function, an image processing function, and a communication function. Accordingly, those skilled in the art understand that the functional blocks can be realized in various forms such as by only hardware, by only software or by a combination of hardware and software, and what realizes them is not limited to either of them.

In addition, the head-mounted display 100 may have functions other than the illustrated functions. Furthermore, some of the illustrated functional blocks may be included in the content processing apparatus 200. In the head-mounted display 100, an image processing section 70 can be realized by the image processing integrated circuit 120 in FIG. 3.

In the head-mounted display 100, the image processing section 70 includes a data acquiring section 71 that acquires various types of data from the stereo camera 110 and the motion sensor 148, a control plane generating section 76 that generates a control plane, a control plane map storage section 78 that stores the distribution of positional information regarding the control plane, a superimposed image control section 88 that controls a state of a superimposed image, a superimposed image data storage section 90 that stores data of the superimposed image, a display image generating section 80 that generates data of a display image, and an output control section 82 that outputs data of the display image. The image processing section 70 further includes a state information acquiring section 84 that serially acquires state information regarding the head-mounted display 100 and real objects, and an object information storage section 86 that stores data related to positions of the real objects.

At a predetermined rate, the data acquiring section 71 acquires various types of data continuously acquired by the stereo camera 110 and the motion sensor 148. Specifically, the data acquiring section 71 includes a captured image acquiring section 72 and a sensor data acquiring section 74. At a predetermined frame rate, the captured image acquiring section 72 acquires data of images captured with the stereo camera 110. At a predetermined rate, the sensor data acquiring section 74 acquires measurement value data of acceleration, angular acceleration, and the like measured by the motion sensor 148.

The state information acquiring section 84 serially acquires data of captured images from the captured image acquiring section 72, executes the Visual SLAM mentioned above, and acquires, at a predetermined rate, the states of objects in the real world such as the position and posture of the head-mounted display 100, and three-dimensional positional information regarding surrounding real objects. Also, the state information acquiring section 84 may serially acquire values of measurement by the motion sensor 148 from the sensor data acquiring section 74 and integrate the values with results of analysis by Visual SLAM to enhance state information precision.

Note that, as long as the state information mentioned above can be acquired serially, the technique to sense real objects performed by the state information acquiring section 84 and the expression format of sensing results are not limited particularly. For example, the state information acquiring section 84 may sense the distances to real objects by TOF (Time Of Flight). TOF is a well-known technology to determine the distance to a subject on the basis of the elapsed time between emission of reference light such as infrared light and observation of its reflection light. The object information storage section 86 stores three-dimensional positional information regarding real objects, for example, data of an environmental map, acquired by the state information acquiring section 84. On the basis of the latest acquired data, the state information acquiring section 84 may update and correct data stored on the object information storage section 86 as appropriate.

On the basis of real object positional information stored on the object information storage section 86 and positional information regarding the head-mounted display 100 acquired by the state information acquiring section 84, the control plane generating section 76 determines distances from the head-mounted display 100 to real objects, and generates data of the control plane such that the control plane corresponds to the distances. As a result, when the distances to the real objects change due to movement of a user or the like, the control plane also changes accordingly.

The control plane generating section 76 may fix part of the control plane corresponding to real objects such as the ceiling that have approximate distances that have been known in advance, independently of positional information regarding sensed real objects. Hence, even if the acquisition precision of the distances to real objects is low due to scarce feature points or the like, an approximately proper virtual distance can be set. The control plane generating section 76 generates a control plane map that is centered around the head-mounted display 100 and the user's head, consequently, and represents the distribution of positions of the control plane in a predetermined range of directions (favorably, all directions) wider than the visual field, and stores the control plane map on the control plane map storage section 78.

It is sufficient if the expression format of the positional information regarding the control plane represented by the control plane map is a parameter uniquely specifying the values of distances from the head-mounted display 100 and may not be distance values themselves. For example, the positional information may be represented by the reciprocals of the distances from the head-mounted display 100 to the control plane. Since the reciprocals of the distances are proportional to parallax generated to left and right images, this is convenient in terms of the scale factor for distance variation. That is, for nearby objects, parallax changes significantly along with small variations in distance, and the apparent sense of distance is also affected significantly, in contrast, for distant objects, the sense of distance is less affected even with the same extent of variation in distance.

By expressing the positional information regarding the control plane using the reciprocals of the distances, the adjustment width of the control plane can be optimized according to the proximity or distance of real objects, and the control plane which is robust in terms of the distance acquisition precision can be set stably. Note that the control plane generating section 76 favorably excludes, from the basis for setting the control plane, positional information regarding real objects such as the hands of the user that move in a real space. Hence, it is possible to prevent the control plane from varying due to the effect of moving objects, and prevent a superimposed image from being affected.

Note that, in a case where a main display target is a virtual space, the state information acquiring section 84 acquires data of an environmental map according to settings of a program such as a game defining a configuration of the virtual space, and stores data on the object information storage section 86 in advance. Hence, similarly to what is mentioned above, the control plane generating section 76 generates a control plane. In addition, in a case of a light-transmissive display, a control plane can be generated by processes similar to those performed by the head-mounted display 100 mentioned thus far, if a stereo camera is mounted on the light-transmissive display.

At a predetermined rate, the superimposed image control section 88 decides a virtual distance of a superimposed image during a period in which the superimposed image needs to be displayed. As mentioned above, the superimposed image control section 88 basically places a superimposed image in front of a control plane. Because of this, the superimposed image control section 88 first retrieves the latest control plane map from the control plane map storage section 78, and generates a corresponding control plane. Then, the superimposed image control section 88 determines a distance from the user to the control plane in the line-of-sight direction of the head-mounted display 100 and the line-of-sight direction of the user, consequently.

Here, the distance to the control plane in the line-of-sight direction is not precisely limited to the distance to the control plane along the optical axis of a virtual camera, but it is sufficient if the distance is a numerical value representing the interval between an area in the control plane corresponding to the visual field and the user's head. For example, the superimposed image control section 88 may generate a predetermined number of virtual rays (rays) from different pixels on a view screen, determine the distance to the control plane in each direction, and then determine the average of the distances to derive the final distance. For this process, ray tracing used in computer graphics rendering can be applied.

According to the thus-determined distance to the control plane, the superimposed image control section 88 decides a virtual distance of a superimposed image according to a predetermined rule. The decision rule is not limited particularly as long as the virtual distance is shorter than the distance to the control plane, and increases or decreases corresponding to the increase or decrease of the distance to the control plane. As mentioned above, the virtual distance may be a distance to a position in front of the control plane by a predetermined interval, a distance equal to a predetermined percentage of the distance to the control plane, or the like. The superimposed image control section 88 decides a virtual distance at predetermined time intervals. At this time, the superimposed image control section 88 may implement a filtering process in a temporal direction on the basis of previous temporal changes of the virtual distance, and decide the latest virtual distance. Hence, the superimposed image can be displaced more smoothly.

Note that an optimum range of the virtual distance is set in advance taking into account the ease of viewing for the user. In a case where the initially calculated virtual distance falls below the optimum range, the superimposed image control section 88 sets the virtual distance to the lower limit of the optimum range, and, in a case where the initially calculated virtual distance exceeds the optimum range, the superimposed image control section 88 decides an upper limit of the optimum range as the final virtual distance. For example, the lower limit of the optimum range is 0.5 m, the upper limit of the optimum range is 1.2 m, and so on. The superimposed image control section 88 also decides a size of the superimposed image in the three-dimensional space according to the decided virtual distance. Specifically, the superimposed image control section 88 increases the size of the superimposed image as the virtual distance increases. Hence, independently of the virtual distance, the apparent size (the size on the display image) of the superimposed image is kept the same, and the visual perceptibility of characters and the like is prevented from changing.

When there are a plurality of superimposed images that should be displayed simultaneously and it is necessary to vary the sense of distance for the superimposed images, the superimposed image control section 88 appropriately changes the intervals between the superimposed images in the line-of-sight direction according to the distance from the user to the control plane.

Qualitatively, if the distance from the user to the control plane is short, the intervals between the superimposed images are reduced, and, if the distance from the user to the control plane is long, the intervals between the superimposed images are increased. This ensures that the sense of distance between the superimposed images is appropriately perceived independently of the proximity or distance of the superimposed images.

The superimposed image data storage section 90 stores model data necessary for rendering a superimposed image. For example, the superimposed image data storage section 90 stores character data displayed on superimposed images, and data such as placement of characters and figures, shapes of the backgrounds, sizes on display images, colors, and the like in association with identification information regarding the superimposed images. Also, the superimposed image data storage section 90 may store, for each superimposed image, data related to a virtual distance decision rule, a superimposed images that should be displayed simultaneously, a positional relation between the superimposed images, and the like.

In the see-through mode, the display image generating section 80 generates data of a display image including a see-through image. Note that, as mentioned above, the main image generated by the display image generating section 80 is not limited to see-through images. The display image generating section 80 also retrieves corresponding data from the superimposed image data storage section 90 during a period in which a superimposed image need to be displayed, and generates a display image including the superimposed image placed at a decided virtual distance. Specifically, the display image generating section 80 displays a superimposed image in left eye and right eye display images at an offset amount (parallax) corresponding to the virtual distance.

The output control section 82 acquires data of the display image from the display image generating section 80, implements a predetermined process, and outputs the data to the display panel 122. The display image includes the pair of the left eye and right eye images, each of which is synthesized with a superimposed image in some cases. The output control section 82 may correct the display image in a way that counteracts distortion aberration and chromatic aberration such that an undistorted image is visually perceived when seen through the eye pieces. In addition, the output control section 82 may perform various types of data conversion corresponding to the display panel 122.

Next, operations performed by the head-mounted display 100 that can be realized by the configuration above are explained. FIG. 11 is a flowchart depicting a processing procedure by which the image processing section 70 of the head-mounted display 100 causes a superimposed image to be displayed in a see-through mode. This flowchart is started at a timing when the see-through mode is started by some trigger in a state where a user is wearing the head-mounted display 100.

Note that it is assumed that, in parallel with the illustrated procedure, the data acquiring section 71 is continuously acquiring images captured with the stereo camera 110 and values of measurement by the motion sensor 148 (sensor data). In addition, it is assumed that the state information acquiring section 84 is executing Visual SLAM using data of the captured images, the position and posture of the head-mounted display 100 are tracked, and an environmental map is generated. The display image generating section 80 starts a process of generating data of a see-through image using the latest captured image and causing the display panel 122 to display the see-through image (S10).

Meanwhile, the control plane generating section 76 prepares a predetermined control plane map in an initial state (S12). For example, the control plane generating section 76 sets the control plane map in the initial state having the same positional information values in all directions. This corresponds to assuming that the control plane in the initial state is the inner surface of a sphere. At this time, the radius of the sphere is 2 m or the like taking into consideration the range of a typical play area or the like. Then, the control plane generating section 76 decides whether or not to update the control plane map. In a case where the control plane map is to be updated (Y at S14), the control plane generating section 76 updates the control plane map on the basis of three-dimensional positional information regarding real objects stored on the object information storage section 86 and positional information regarding the head-mounted display 100 (S16).

For example, the control plane generating section 76 decides to update the control plane map only during a period in which the speed of the head-mounted display 100, that is, the speed of the user's head, is equal to or faster than a predetermined value at which the head-mounted display 100 and the user's head can be regarded as moving. In many cases, during a period in which the user is moving, the distances between the head-mounted display 100 and real objects are changing, and accordingly it becomes necessary to update the control plane. Even during a period in which the user is stationary, three-dimensional information regarding real objects can be updated and corrected as appropriate by the process of Visual SLAM. If the control plane reflects the updated and corrected three-dimensional information immediately, the virtual distance changes during a period in which a superimposed image is being displayed, and a possibility that the user who is paying attention to the image while being stationary notices changes in the superimposed image increases.

By updating the control plane map only during a period in which the user is moving, a possibility that the control plane can be optimized without being noticed by the user increases. During a period in which the user is stationary and the control plane map is not to be updated (N at S14), the control plane generating section 76 skips the updating process at S16. Also, the control plane generating section 76 repeats the process of updating the control plane map during an updating period (S14 and S16) thereafter.

When it becomes necessary to display a superimposed image (Y at S18), the superimposed image control section 88 generates a control plane on the basis of the latest control plane map. Then, the superimposed image control section 88 derives the distance from the user to the control plane in the line-of-sight direction of the user on the basis of the posture of the head-mounted display 100, and then decides a virtual distance of a superimposed image (S20). At this time, the superimposed image control section 88 also decides a size of the superimposed image in the three-dimensional space on the basis of the decided virtual distance.

The display image generating section 80 renders a view of the superimposed image as seen from a virtual camera corresponding to the position/posture of the head-mounted display 100, superimposes the view on the see-through image, and then outputs the superimposed view and see-through image to the display panel 122 via the output control section 82 (S22). As mentioned above, at S22, the output control section 82 may perform a necessary process such as a process of implementing correction according to the distortion of the eye pieces of the head-mounted display 100.

If it is not necessary to end the see-through mode (N at S24), the image processing section 70 repeats the processes at S14 to S22. Note that the processes at S20 and S22 are skipped during a period in which a superimposed image is not displayed (N at S18). When it becomes necessary to end the see-through mode, the image processing section 70 ends all the processes (Y at S24).

As frames of captured images are sequentially collected and Visual SLAM progresses, positional information regarding real objects is newly acquired or corrected. The control plane generating section 76 accordingly updates the control plane map to hence construct a control plane corresponding to the positions of surrounding real objects. Although there is also a possibility that part of the control plane corresponding to a real object such as a wall with scarce feature points is not updated from the initial state, it is possible to display a superimposed image at an approximately appropriate position independently of whether or not the control plane is updated, by appropriately setting the control plane in the initial state.

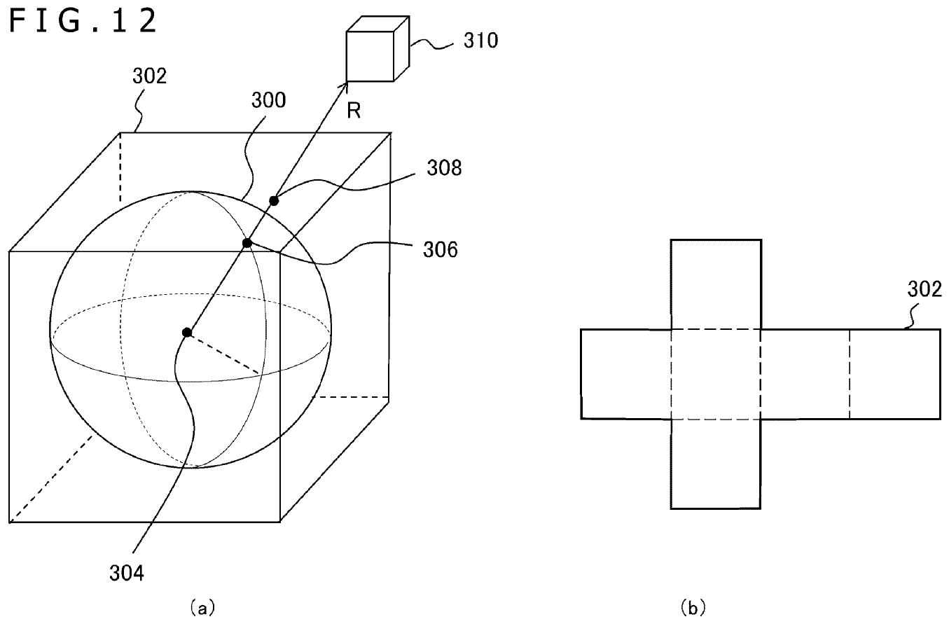

FIG. 12 is a drawing for explaining an example in which a cube map is used as a data format of a control plane map. (a) depicts the relation between a polar coordinate system having directions (latitudes and longitudes) as variables and the cube map surface. The cube map surface 302 is a surface forming a virtual cube circumscribing a polar coordinate system 300 having a certain radius. The center of the polar coordinate system 300 is a predetermined representative point 304 set as the position of the head such as the center of gravity of the head-mounted display 100.

Coordinates 306 representing a direction in the polar coordinate system 300 are mapped to a position 308 at which a straight line from the representative point 304 to the coordinates 306 intersects the cube map surface 302. (b) depicts a six-sided unfolded view of the cube map surface 302. Two-dimensional positional coordinates on the cube map surface 302 have one-to-one relation with directions from the representative point 304. That is, by representing parameter values for each pixel of the cube map, directions and parameters can be associated with each other.

Such a cube mapping technology is known as one kind of means for expanding a panoramic image into two-dimensional data. In the present embodiment, a control plane map having pixel values of the cube map as positional information regarding a control plane is generated. Note that the data format of the control plane map is not limited to cube maps. For example, a polar coordinate system may be used, or any of techniques for expressing panoramic images such as cylindrical surfaces or torus surfaces may be applied. Note that, compared with other expression formats, cube maps require low load related to arithmetic operations or data retrieval, and the adjustment of boundary conditions required for cube maps is also easier.

Note that positional information regarding a control plane is not limited to being represented discretely on a map and may be represented by a continuous function with respect to directions. For example, the control plane generating section 76 may fit spherical harmonic functions to the three-dimensional positional coordinates of real objects and treat the spherical harmonic functions as positional information regarding the control plane. In this case, compared to an aspect in which positional information is represented by two-dimensional distribution such as a cube map, there is a possibility that arithmetic operation load decreases depending on the degree of the spherical harmonic functions. In addition, the memory capacity for storing data and the load related to retrieval can be reduced.

In a case where a cube map is used, the control plane generating section 76 first determines distances R and their directions to the three-dimensional positional coordinates of feature points sensed on the surface of a real object 310, starting from the representative point 304. Then, on the basis of the data, the control plane generating section 76 decides positional information regarding a control plane with respect to discrete directions corresponding to respective pixels on the map, and writes the positional information on a map plane. For example, the resolution of the control plane map is 64×64 pixels or the like for each surface of the cube map.

Since it is not constantly the case that feature points of the real object 310 are located in directions for which positional information should be represented in the map, by a filtering process, the control plane generating section 76 derives positional information regarding predetermined directions using the positional coordinates of nearby feature points. Further, the control plane generating section 76 prevents the control plane from changing rapidly due to newly obtained positional coordinates of real objects, noise of distance measurement values, and the like, by implementing a filtering process in the temporal direction and deciding positional information regarding the control plane.

As mentioned above, to cause the virtual distance of a superimposed image to change smoothly, it is desirable that the control plane has a smoothed plane without sharp irregularities while following distribution of distances to real objects. In view of this, the control plane generating section 76 implements a filtering process on a control plane map using a Jacobi over relaxation (JOR) method or the like such that changes in gradient (second derivative) of positional information regarding the control plane falls within a predetermined range.

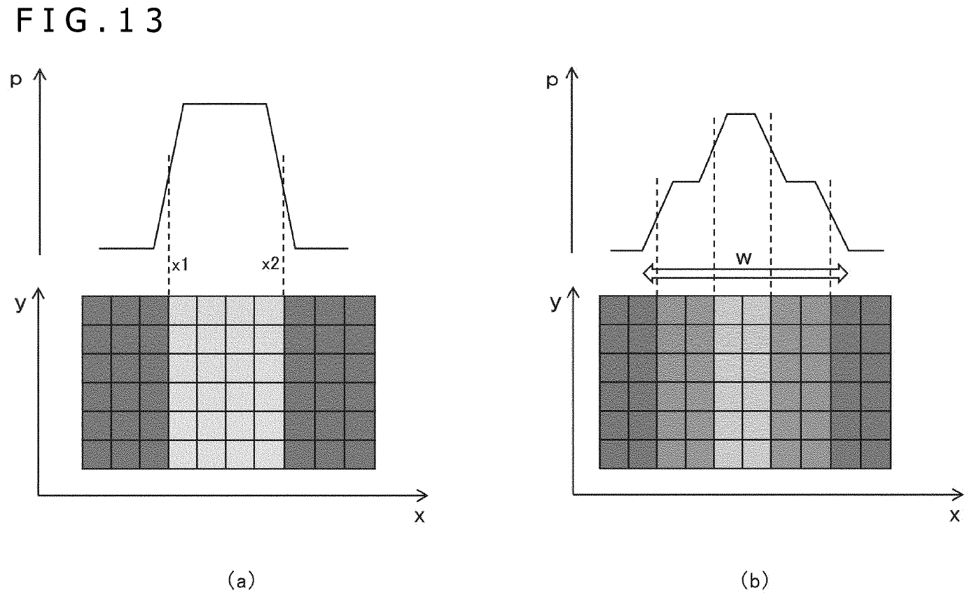

FIG. 13 is a drawing for explaining an example of a filtering process that a control plane generating section 76 implements on the control plane map. The top sides of (a) and (b) schematically depict examples of horizontal (x direction) changes in positional information p (e.g., the reciprocal of the distance from the head-mounted display 100) on the control plane map, and the bottom sides of (a) and (b) schematically depict two-dimensional (x direction and y direction) pixel columns of a corresponding area on the control plane map.

In the positional information distribution before filtering depicted in (a), the positional information p changes significantly near positions x1 and x2, and this increases changes in gradient between adjacent pixels. In contrast, as depicted in (b), the control plane generating section 76 implements a filtering process such that a propagation range w of changes falls within predetermined values while propagating changes in the positional information p to surrounding pixels and keeping changes in gradient equal to or smaller than a predetermined value. For example, the control plane generating section 76 executes the following recurrence formula a predetermined number of times.

$${P}_{k + 1} = {P}_{k} - ω \cdot D ( A \cdot {P}_{k} ) \qquad [ Math . 1 ]$$

Here P represents a positional information vector representing the positional information p regarding all pixels on the control plane map with a one-dimensional sequence. A represents a matrix for determining a Laplacian of each element (each piece of positional information p) of a positional information vector P, that is, the sum of the second derivatives in the x direction and the y direction. That is, (A. P) substantially represents a result of the application of a 4-neighbor Laplacian filter to each pixel on the map plane.

ω represents a coefficient for enabling a filter operation only during a period in which the head-mounted display 100 is moving. For example, if the speed of the head-mounted display 100 falls within a predetermined range where the head-mounted display 100 can be regarded to be stationary, ω=0, and otherwise, ω=1. Note that continuity near speed boundary values may be ensured by gradually increasing ω from 0 to 1 according to the speed of the head-mounted display 100. The coefficient ω ensures that the control plane is adjusted and superimposed images are prevented from appearing to be moving unnaturally during a period in which a possibility that the user is stationary and is gazing at a display image is high. Note that parameters (parameters that control the coefficient) used for the assessment as to whether or not the head-mounted display 100 is stationary are not limited to the speed of the head-mounted display 100 and may be the angular velocity or acceleration of the head-mounted display 100 or may be a combination of two or more of the speed, angular velocity, and acceleration of the head-mounted display 100.

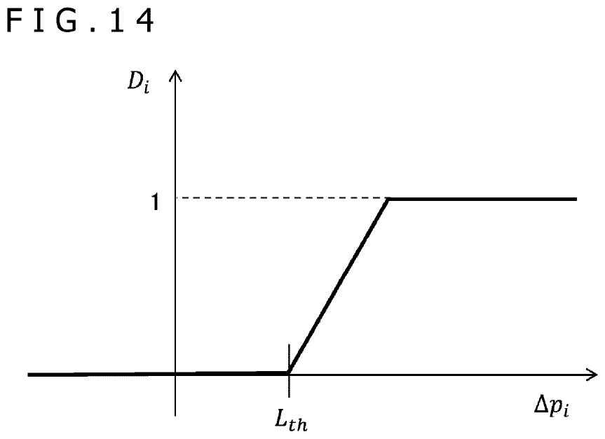

D represents a diagonal matrix for controlling an adjustment amount in the filtering process according to the Laplacian of each piece of positional information. FIG. 14 depicts an example of changes in a diagonal element Dᵢ corresponding to changes in the Laplacian Δpᵢ of i-th piece of positional information pᵢ. In this example, the element Dᵢ is 0 when Δpᵢ is equal to or smaller than a threshold value Lₜₕ, and is a value that gradually increases according to the increase of Δpᵢ and is saturated at 1 when Δpᵢ exceeds the threshold value Lₜₕ. Note that changes in the element Dᵢ with respect to Δpᵢ are not limited to linear changes. According to the matrix D having such Dᵢ as a diagonal element, the positional information pᵢ is adjusted with a greater change when changes in gradient of the corresponding positional information pᵢ are significant, and the adjustment is stopped at the time point when the changes converge to be equal to or smaller than the threshold value Lₜₕ.

The control plane generating section 76 implements the filtering process at a predetermined frequency, and causes changes in the positional information p to be propagated to surrounding pixels and smooths changes in gradient by applying the recurrence formula described above a predetermined number of times in one filtering process. For example, the control plane generating section 76 executes the filtering process every 1/30 seconds, and implements the arithmetic operation described above up to eight times in one filtering process. By such a filtering process, changes in gradient of the positional information p on the control plane map are smoothed to values approximately smaller than the threshold value Lₜₕ. In addition, by providing the upper limit in the number of times of arithmetic operations of the recurrence formula, the propagation range of irregularities is limited.

Hence, the control plane with reduced sharp irregularities can be generated while following distribution of distances to real objects, and a superimposed image can be expressed with a sense of distance approximately corresponding to the distance range of the real objects. In a case where a cube map is used, positional information that constitutes each surface is stored in continuous memory areas. Accordingly, the generation of the positional information vector P is easy, and high-speed arithmetic operations can be realized easily. Note that the threshold value Lₜₕ is set in advance to an optimum value according to the surrounding environment or the like. Here, the threshold value Lₜₕ may be a fixed value for the whole control plane map or may be values that are distributed across the map plane.

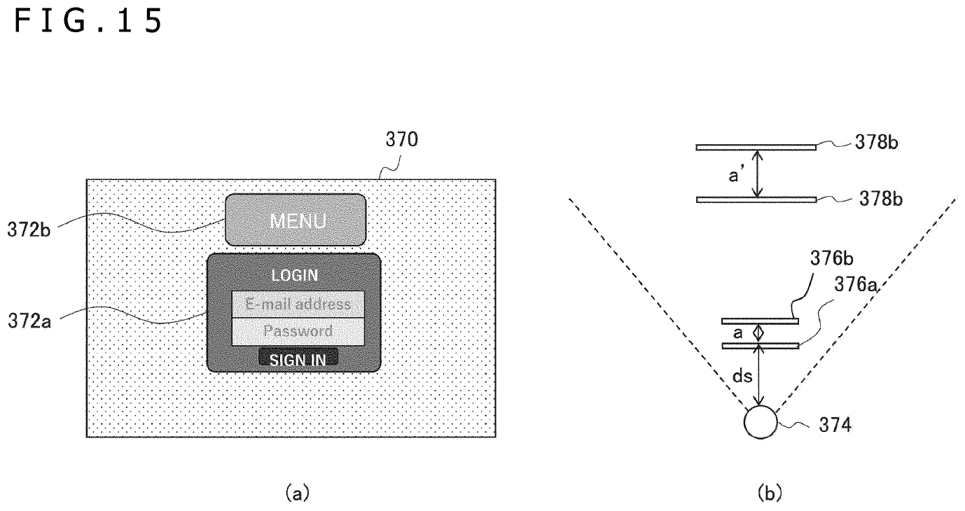

FIG. 15 is a drawing for explaining a principle for deciding virtual distances when a plurality of superimposed images are displayed at different distances. (a) schematically depicts only superimposed images in a display image 370. Note that right eye and left eye display images having parallax are actually generated. In this example, the display image 370 has a configuration in which two superimposed images 372a and 372b are placed vertically. For example, the superimposed image 372a displayed at the middle on the image plane is a main image that accepts input, and the superimposed image 372b thereabove is a secondary image for calling up another menu.

In this case, by displaying the superimposed image 372a at a closer distance than the superimposed image 372b, it is possible to cause the hierarchical relation between the two superimposed images to be understood intuitively. Note that the display content of superimposed images and the purpose of setting a difference in distance are not limited particularly. In any case, in a case where a difference in distance between a plurality of superimposed images is set in this manner, it is crucial that a user can perceive the difference at a glance. For example, in a case where the superimposed images 372a and 372b are displayed closer to the user, the distance relation can be perceived easily even if the interval between them is relatively short. In contrast, in a case where the superimposed images 372a and 372b are displayed farther, placing the superimposed images 372a and 372b with an interval therebetween which is the same as the case where the superimposed images 372a and 372b are displayed closer makes it difficult to perceive the distance relation between them.

In view of this, the control plane generating section 76 adjusts the interval between superimposed images according to virtual distances from a user based on a control plane. (b) represents a relative distance between superimposed images in two cases. Qualitatively, when the virtual distance from a user 374 is short as in a case of superimposed images 376a and 376b, the control plane generating section 76 reduces an interval a between them. When the virtual distance from the user 374 is long as in a case of superimposed images 378a and 378b, the control plane generating section 76 increases an interval a′ between them. For example, the control plane generating section 76 decides a virtual distance of any of superimposed images that should be displayed simultaneously on the basis of the control plane, and decides an interval between the superimposed images on the basis of the virtual distance.

In the example depicted in the drawing, the virtual distance of the superimposed image 376b is set to ds+a by first deciding a virtual distance ds of the superimposed image 376a, and accordingly deciding the interval a. The relation between virtual distances and intervals between the superimposed images is not limited particularly as long as the relation satisfied the nature described above, and may be a proportional relation or the like. In addition, the number of superimposed images to be displayed simultaneously is not limited to two. By such an adjustment of the interval between superimposed images, it becomes possible to cause the distance relation to be perceived at a glance independently of the proximity or distance of the superimposed images, and it becomes easier to represent the role of each superimposed image by placement of the superimposed images in the depth direction.

According to the present embodiment mentioned thus far, on a head-mounted display that realizes stereoscopic view, a control plane is generated to correspond to distribution of distances of objects in a three-dimensional space within a visual field, and the virtual distance of a superimposed image is decided according to the distance from a user to the control plane in the line-of-sight direction. Hence, a superimposed image which is not preferable to be hidden due to its nature can be presented naturally by placing the superimposed image in front of the objects also in the three-dimensional space. In addition, by placing the superimposed image at a distance which is approximately the same as the distances of the objects, it is easier to focus on the superimposed image. As a result, the user can visually perceive the superimposed image without difficulty with a similar sense to that before the superimposed image is displayed.

In addition, by preparing in advance a continuous and smoothed plane as a control plane on the basis of which a virtual distance is decided, the superimposed images can be displaced smoothly even if the user rotates her/his head in a state where the superimposed images are being displayed. By preparing the control plane for directions which are in a wide range from the user, it is possible to follow a sudden turn or the like also. Since adjustments can progress during a period in which the user is rotating her/his head and the adjustments can be completed by the time when the head is stopped, the superimposed images are constantly displayed at proper positions in a situation where the user pays attention to the display.

The present invention has been explained thus far on the basis of an embodiment thereof. The embodiment illustrates an example, and those skilled in the art understand that various modification examples are possible in terms of combinations of respective constituent elements and respective processing processes of the embodiment, and also, such modification examples are within the scope of the present invention.

### INDUSTRIAL APPLICABILITY

As mentioned above, the present invention can be used for an image display system such as a head-mounted display and a game console.

### REFERENCE SIGNS LIST

10: Image display system
70: Image processing section
72: Captured image acquiring section
74: Sensor data acquiring section
76: Control plane generating section
78: Control plane map storage section
80: Display image generating section
82: Output control section
84: State information acquiring section
86: Object information storage section
88: Superimposed image control section
90: Superimposed image data storage section
100: Head-mounted display
110: Stereo camera
120: Image processing integrated circuit
122: Display panel
136: CPU
138: GPU
200: Content processing apparatus

1. A head-mounted display system that realizes stereoscopic view, the head-mounted display system comprising:
one or more storage media storing instructions; and
one or more processors configured to execute the instructions to cause the head-mounted display system to:
set a control plane corresponding to a distribution of distances between a user and real objects in a display-target virtual three-dimensional space;
determine a virtual distance of a superimposed image to be displayed according to a distance to the control plane in a line-of-sight direction;
generate data of a display image including the superimposed image in a state where the superimposed image is placed at the virtual distance in the display-target virtual three-dimensional space; and
output the data of the display image to a display panel.

2. The head-mounted display system of claim 1, wherein the execution of the instructions further cause the head-mounted display system to:
update a control plane map representing a distribution of positional information regarding the control plane in a predetermined range of directions centered around a user's head according to a change in the distribution of distances; and
determine the virtual distance based at least in part on the control plane generated based at least in part on the control plane map.

3. The head-mounted display system of claim 2, wherein the execution of the instructions further cause the head-mounted display system to represent the distribution of the positional information regarding the control plane as the control plane map on a cube map including a surface of a virtual cube centered around the user's head.

4. The head-mounted display system of claim 2, wherein the execution of the instructions further cause the head-mounted display system to:
serially acquire three-dimensional positional information regarding the head-mounted display system and a real object based at least in part on an image captured with a mounted camera; and
update the control plane map based at least in part on a change in the three-dimensional positional information.

5. The head-mounted display system of claim 4, wherein the execution of the instructions further cause the head-mounted display system to update the control plane map during a period in which at least one of a speed, angular velocity, or acceleration of the user's head is equal to or greater than a predetermined value.

6. The head-mounted display system of claim 2, wherein the execution of the instructions further cause the head-mounted display system to implement a filtering process of reducing a second derivative value of a numerical value representing the positional information on the control plane map at a predetermined frequency.

7. The head-mounted display system of claim 1, wherein the execution of the instructions further cause the head-mounted display system to change an interval in a line-of-sight direction of a plurality of superimposed images to be displayed according to the distance to the control plane.

8. The head-mounted display system of claim 1, wherein the execution of the instructions further cause the head-mounted display system to:
determine the virtual distance at a predetermined time interval, and
implement a filtering process in a temporal direction based at least in part on a temporal change in the virtual distance.

9. An image display method comprising:
setting a control plane corresponding to distribution of distances between a user and real objects in a display-target virtual three-dimensional space;
determining a virtual distance of a superimposed image to be displayed, according to a distance to the control plane in a line-of-sight direction;
generating data of a display image including the superimposed image in a state where the superimposed image is placed at the virtual distance in the display-target virtual three-dimensional space; and
outputting the data of the display image to a display panel.

10. (canceled)

11. The image display method of claim 9, further comprising:
updating a control plane map representing a distribution of positional information regarding the control plane in a predetermined range of directions centered around a user's head according to a change in the distribution of distances; and
determining the virtual distance based at least in part on the control plane generated based at least in part on the control plane map.

12. The image display method of claim 11, further comprising representing the distribution of the positional information regarding the control plane as the control plane map on a cube map including a surface of a virtual cube centered around the user's head.

13. The image display method of claim 11, further comprising:
serially acquiring three-dimensional positional information regarding a head-mounted display and a real object based at least in part on an image captured with a mounted camera; and
updating the control plane map based at least in part on a change in the three-dimensional positional information.

14. The image display method of claim 11, further comprising implementing a filtering process of reducing a second derivative value of a numerical value representing the positional information on the control plane map at a predetermined frequency.

15. The image display method of claim 9, further comprising changing an interval in a line-of-sight direction of a plurality of superimposed images to be displayed according to the distance to the control plane.

16. The image display method of claim 9, further comprising:
determining the virtual distance at a predetermined time interval; and
implementing a filtering process in a temporal direction based at least in part on a temporal change in the virtual distance.

17. One or more non-transitory computer-readable storage media storing instructions that, upon execution by one or more processors of a head-mounted display system, cause the head-mounted display system to perform operations comprising:
setting a control plane corresponding to a distribution of distances between a user and real objects in a display-target virtual three-dimensional space;
determining a virtual distance of a superimposed image to be displayed on a display panel of the head-mounted display system, according to a distance to the control plane in a line-of-sight direction;
generating data of a display image including the superimposed image in a state where the superimposed image is placed at the virtual distance in the display-target virtual three-dimensional space; and
outputting the data of the display image to the display panel.

18. The non-transitory computer-readable storage media of claim 17,
wherein execution of the instructions causes the head-mounted display system to perform operations further comprising:
updating a control plane map representing a distribution of positional information regarding the control plane in a predetermined range of directions centered around a user's head according to a change in the distribution of distances; and
determining the virtual distance based at least in part on the control plane generated based at least in part on the control plane map.

19. The non-transitory computer-readable storage media of claim 17, wherein execution of the instructions causes the head-mounted display system to perform operations further comprising changing an interval in a line-of-sight direction of a plurality of superimposed images to be displayed according to the distance to the control plane.

20. The non-transitory computer-readable storage media of claim 17, wherein execution of the instructions causes the head-mounted display system to perform operations further comprising:
determining the virtual distance at a predetermined time interval; and
filtering in a temporal direction based at least in part on a temporal change in the virtual distance.
